(19) United States
(12) Patent Application Publication
(10) Pub. No.: US 2024/0075330 A1
(43) Pub. Date: Mar. 7, 2024

(54) FIRE TRAINING FACILITY WHICH SIMULATES AN ELECTRIC VEHICLE CATCHING FIRE

(71) Applicant: Dräger Safety AG & Co. KGaA, Lübeck (DE)

(72) Inventors: Carsten JOESTER, Lübeck (DE); Johannes SOHNREY, Lübeck (DE)

(21) Appl. No.: 18/263,403

(22) PCT Filed: Jan. 26, 2022
(86) PCT No.: PCT/DE2022/100066

§ 371 Date: Jul. 28, 2023

(30) Foreign Application Priority Data
Feb. 3, 2021 (DE) 10 2021 102 467.6

(51) Int. Cl. A62C 99/00; A62C 3/06; A62C 3/07; A62C 3/16

(52) U.S. Cl. CPC A62C 99/0081; A62C 3/06; A62C 3/07; A62C 3/16

(57) ABSTRACT

A fire training facility, which simulates a fire onboard an electric vehicle. A dummy vehicle has the external dimensions of a real vehicle and has a dummy of a rechargeable battery and at least one dummy of a tire of the vehicle. The rechargeable battery dummy is positioned onboard the dummy vehicle in the same way as a rechargeable battery onboard a real vehicle. A smoke pot or fog pot generates fog, which is released from the rechargeable battery dummy. A flame generator of the rechargeable battery dummy generates flames, which are released from the rechargeable battery dummy. The dummy tire or each dummy tire is positioned onboard the dummy vehicle in the same way as the corresponding tire onboard a vehicle. A flame generator of the dummy tire generates flames, which are released from the dummy tire.

### CROSS REFERENCE TO RELATED APPLICATIONS

This application is a United States National Phase Application of International Application PCT/DE2022/100066, filed Jan. 26, 2022, and claims the benefit of priority under 35 U.S.C. § 119 of German Application DE 102021102467.6, filed Feb. 3, 2021, the entire contents of which are incorporated herein by reference.

### TECHNICAL FIELD

The present invention pertains to a fire training facility that simulates the fire of an electric vehicle. Firefighters can train on how to put out the fire of an electric vehicle at this fire training facility. Such a fire may especially occur on a public street, in a garage, onboard a transportation vehicle for electric vehicles or even in a factory for electric vehicles.

### TECHNICAL BACKGROUND

Note: The term “fire training facility” denotes hereinafter a physical object and not a simulation program, which runs on a computer.

Fire training facilities for different applications are known, e.g., from U.S. Pat. No. 10,573,195 B1, DE 102 08 980 A1, DE 10 2004 058 190 A1, DE 10 2006 020 944 B3, DE 10 2014 016 311 A1, DE 10 2014 016 310 A1 and DE 10 2017 008 009 B3.

German standard DIN 14097 specifies requirements on a firefighter training facility. DIN 14093 specifies requirements on a respirator training facility.

### SUMMARY

A basic object of the present invention is to provide a fire training facility, which simulates in a realistic manner a situation that frequently occurs in reality during the fire of a vehicle.

The present invention is accomplished by a fire training facility with features according to the invention. Advantageous embodiments are described herein.

The fire training facility according to the present invention comprises a dummy of a vehicle. The vehicle is preferably a land vehicle, especially preferably a road vehicle with four wheels or with two wheels, especially a passenger vehicle or a commercial vehicle, or a railway vehicle or an agricultural vehicle. This dummy vehicle comprises at least one dummy of a rechargeable battery (rechargeable battery dummy) and at least one dummy of a tire of a real vehicle. “The vehicle” is defined as a real vehicle, which can catch fire. A “dummy” of a (real) vehicle or of a (real) vehicle component or of another object is defined as a physical object (mock-up) that has the external dimensions of this vehicle or vehicle component or other object. A “rechargeable battery” is defined as a rechargeable supply unit for electrical voltage, especially a battery. The dummies for the vehicle components are arranged in the dummy vehicle at the positions, at which the vehicle components are usually arranged or at least can be arranged in the real vehicle simulated by the dummy vehicle.

The rechargeable battery dummy or each rechargeable battery dummy comprises a respective smoke pot or fog pot (fog generator) and a respective flame generator. The smoke pot or fog pot of a rechargeable battery dummy is capable of generating fog, wherein the generated fog is released from the rechargeable battery dummy. The flame generator of a rechargeable battery dummy is capable of generating flames, wherein the generated flames are released from the rechargeable battery dummy.

The dummy tire or each dummy tire comprises a respective flame generator. The flame generator of a dummy tire is capable of generating flames, wherein the generated flames are released from the dummy tire.

More and more electric vehicles, in particular passenger motor vehicles and two-wheelers, but also commercial vehicles and buses, which are driven by a respective electric motor exclusively or at least on some road sections, are traveling in road traffic. The electric motor is supplied with electrical energy by at least one rechargeable battery onboard the vehicle, so that no stationary power supply in the form of an overhead wire or a bus bar is necessary. It is possible that such a road vehicle comprises an internal combustion engine in addition to the electric motor. These electric vehicles have to be produced and transported to a respective delivery point. Vehicles with an electric drive are also increasingly used for agricultural applications or other applications beyond road traffic.

An electric motor of an electric vehicle takes up electrical current with a voltage of several 100 V. It is possible that an electric motor or a rechargeable battery onboard a vehicle catches fire, for example, during a trip or while the rechargeable battery is being charged. In order to put out such a fire, a different process is necessary in many cases than in case of a fire of a vehicle equipped with an internal combustion engine as the only drive.

The fire training facility according to the present invention simulates the fire of a road vehicle or of another vehicle during the operation, wherein an electric motor and at least one rechargeable battery is arranged onboard the real vehicle for supplying the electric motor. In this case, the fire training facility generates different situations, which may occur during the fire of such a real vehicle equipped with an electric motor and with a rechargeable battery.

When a rechargeable battery onboard a vehicle is heated and catches fire, then a chain reaction of different events is frequently triggered. The fire training facility according to the present invention simulates a plurality of possible chain reactions.

The fire training facility according to the present invention contributes to training firefighters and other rescue crew members in a realistic manner on how to carry out the correct actions during the fire of an electric vehicle. Thanks to this training, all passengers of a burning electric vehicle can especially more frequently be rescued more rapidly, and a danger to people outside the burning electric vehicle occurs less often.

Thanks to the fire training facility according to the present invention, it is less often necessary to submerge a burning real electric vehicle entirely in a tub containing water or containing a different extinguishing liquid in order to put out the fire, which is very costly.

When a rechargeable battery of a real electric vehicle catches fire, then the rechargeable battery often discharges both fog and flames. In order to simulate these events realistically, the rechargeable battery dummy or each rechargeable battery dummy comprises a respective smoke pot or fog pot and a respective flame generator. These two generators can preferably be activated independently of one another in order to be able to simulate, as desired, a chronological sequence selected from a plurality of possible chronological sequences. In particular, the situation that a real rechargeable battery discharges fog first and then flames can be simulated.

The dummy vehicle preferably comprises a vehicle body, which comprises the external dimensions of the vehicle body of a real vehicle. The rechargeable battery dummy or each rechargeable battery dummy is located inside this vehicle body of the dummy vehicle. The dummy tire or each dummy tire is fastened, preferably fastened in a rotatable manner, to this vehicle body. The dummy vehicle can especially preferably be moved over a base.

In one embodiment, a dummy electric motor is arranged onboard the dummy vehicle. This dummy electric motor also comprises a smoke pot or fog pot and preferably a flame generator, wherein the fog generated by the smoke pot or fog pot and the flames generated by the optional flame generator are released from the dummy electric motor.

A real vehicle comprises at least one seat and/or at least one seat bench for at least one respective vehicle passenger. The dummy vehicle preferably comprises the dummy of such a seat and/or of such a seat bench. The rechargeable battery dummy or at least one rechargeable battery dummy is arranged under this seat or under this seat bench. This embodiment especially realistically simulates a situation during the fire of a real electric vehicle with a rechargeable battery under a seat or under a seat bench. The seat or this seat bench in the dummy vehicle may realistically make it difficult to access the rechargeable battery dummy.

The dummy vehicle additionally preferably comprises a dummy steering wheel. This dummy steering wheel simulates the boundary condition that the real steering wheel onboard a burning vehicle may make it difficult to access people or objects inside the vehicle. The dummy steering wheel is positioned onboard the dummy vehicle in the same way as a steering wheel onboard a real vehicle. In one embodiment, the steering wheel can be mounted as desired on the left-hand side or on the right-hand side, so that the dummy vehicle simulates, as desired, a vehicle with a left-hand drive or a vehicle with a right-hand drive.

It is possible that a real vehicle comprises both an electric motor and an internal combustion engine. Such a vehicle is also called a hybrid vehicle. The electric motor is supplied with electrical energy by means of a rechargeable battery; the internal combustion engine is supplied with combustible fuel from a fuel tank. The fire training facility according to the present invention is capable in one embodiment of simulating a fire onboard such a hybrid vehicle. According to this embodiment, the dummy vehicle additionally comprises a tank for a combustible fluid, and in particular a tank for combustible fuel. A closure is capable of closing or opening this tank of the dummy vehicle as desired. This embodiment makes it possible to simulate, as desired, the situation
that first the fuel tank catches fire and as a result of this, the rechargeable battery is heated and likewise catches fire, and
that first the rechargeable battery catches fire and then the fuel tank.

In case the closure opens the tank, then oxygen can reach the combustible fluid in the tank. In case the closure closes the tank, then the tank is blocked against the environment.

In one embodiment, both the situation that the fuel tank with the closure put on catches fire and the situation that the open fuel tank catches fire, in which case oxygen from the environment can reach the fuel tank, can be simulated.

During the fire of a real electric vehicle, the components of the vehicle can discharge fog and/or flames in a different order. In order to be able to simulate different situations when using the fire training facility, the fire training facility preferably comprises a signal-processing control device. This control device is capable of actuating the rechargeable battery dummy or least one, preferably each rechargeable battery dummy of the fire training facility. The control device preferably carries out a previously predefined sequence during the actuation, wherein this sequence specifies which dummy rechargeable batteries are activated and then discharge fog and flames and in what order which activated dummy rechargeable batteries are actuated and in what manner. The control device is preferably capable of detecting and processing user inputs. As a result, a user may predefine different sequences, especially different chronological orders, in which the flame generator and/or the smoke pot or fog pot are activated.

In a preferred embodiment, the control device is capable of actuating the rechargeable battery dummy or at least one rechargeable battery dummy, preferably each rechargeable battery dummy such that the following is brought about: At first, the smoke pot or fog pot of the rechargeable battery dummy is activated and starts to discharge fog, which is released from the rechargeable battery dummy. The flame generator of the rechargeable battery dummy is then activated and starts to discharge flames, which are released from the rechargeable battery dummy. It is possible that the rechargeable battery dummy discharges both fog and flames for a period of time. This sequence simulates the fire of a rechargeable battery more realistically than other possible sequences. When a real rechargeable battery catches fire, then frequently first fog is released from the rechargeable battery and then flames are released from the rechargeable battery.

The flame generator of the rechargeable battery dummy or at least one rechargeable battery dummy, preferably of each rechargeable battery dummy comprises two respective components in a preferred embodiment. One component comprises pyrotechnics in the manner of New Year's fireworks; and the other component comprises a burner, which is capable of burning a combustible fluid. The combustible fluid is especially a gas in the gaseous form or liquid form. The rechargeable battery dummy preferably comprises a tank for a combustible fluid. The activated burner is capable of igniting a combustible fluid in this tank.

The two components, i.e., the component with the pyrotechnics and the component with the burner, which can preferably be activated independently of one another. Upon activation of the pyrotechnics, flames are formed, and fog is additionally released. This embodiment makes it possible to realistically simulate different possible situations during the fire of a rechargeable battery. In addition, redundancy is created.

The control device first activates the component with the pyrotechnics and then the component with the burner in a variant of this embodiment. This embodiment simulates the fire of a rechargeable battery in an especially realistic manner. This embodiment especially simulates the following situation, which may occur during the fire of a rechargeable battery: First, fog and a few flames develop, which is simulated due to the activation of the pyrotechnics. Then, high heat as well as many and/or intense flames develop, which is simulated by the burner igniting the combustible fluid. This two-step procedure simulates the burning of a rechargeable battery more realistically than when a burner exclusively ignites a combustible fluid.

When a rechargeable battery catches fire, it is important in many cases to rapidly introduce an extinguishing liquid, especially water, into the interior of the rechargeable battery. One improved embodiment of the fire training facility according to the present invention makes it easy to train firefighters on this procedure. A firefighter frequently uses a so-called fog nozzle to introduce the extinguishing liquid into the interior of an object. A fog nozzle is hollow on the inside and usually rigid, can be introduced, for example, by insertion, into the object, and then sends the extinguishing liquid into the interior of the object.

So that firefighters can train on this procedure, the fire training facility is configured according to the preferred embodiment as follows: At least one rechargeable battery dummy, preferably each rechargeable battery dummy, comprises a respective plate made of a metallic material. This plate forms an area of the outer surface of the rechargeable battery dummy. The plate is detachably connected to the rest of the rechargeable battery dummy. A firefighter can pierce the plate with his fog nozzle and can then introduce an extinguishing liquid through the plate into the interior of the rechargeable battery dummy. The extinguishing liquid cools the rechargeable battery dummy and reduces the feed of oxygen. The plate of the rechargeable battery dummy is pierced during training. Since the plate is fastened detachably, the pierced plate can be easily replaced. A new plate is then available in case of a subsequent additional mission. As a rule, no other components of the rechargeable battery dummy need to be replaced.

Sometimes an electric vehicle catches fire while the rechargeable battery or at least one or even each rechargeable battery of the electric vehicle is being electrically charged at a charging station. The electric vehicle is connected to the charging station by means of a cable. The fire training facility in one embodiment comprises a dummy of a charging station in order to simulate the situation with the cable realistically. This dummy charging station comprises a dummy of a cable, which is preferably fastened to the rechargeable battery dummy in the same way as a real cable is fastened to a real charging station. The dummy cable is connected to the dummy vehicle or can be detachably connected to the dummy vehicle. The position, at which the dummy cable is connected to the dummy vehicle, corresponds to the position, at which a real cable is connected to a real electric vehicle, in order to charge at least one real rechargeable battery of the vehicle.

During a fire of a real electric vehicle, the charging station and/or the cable may make it difficult to access the interior of the electric vehicle. The embodiment with the dummy charging station comprising the dummy cable simulates the situation that a real charging station makes it difficult to access a burning electric vehicle.

An electric vehicle sometimes catches fire while the electric vehicle is parked in a garage. In one preferred embodiment, the fire training facility additionally comprises a garage. This garage is so large that it is capable of accommodating and enclosing, preferably capable of fully enclosing the dummy vehicle.

The dummy vehicle can preferably be put as desired into a position, in which the dummy vehicle is located inside the garage, or in a position, in which the dummy vehicle is positioned outside the garage.

In one embodiment, this garage comprises at least one door. The situation that the door or each door is closed and the rechargeable battery dummy is located in the interior of the thereby closed garage can preferably be established. The door or at least one, preferably each door can especially preferably be opened only by force. This situation simulates the real situation that an electric vehicle inside a garage catches fire and the door or at least one door can no longer be opened regularly, but only by force. The dummy vehicle can especially also be put into a position, in which the dummy vehicle is located partially inside the garage and partially outside the garage.

In another embodiment, the fire training facility comprises two dummy vehicles, especially a first dummy vehicle inside the garage and a second dummy vehicle outside the garage. This embodiment spares the need to configure the dummy vehicle such that it can be moved over the base. In addition, the situation that two electric vehicles, namely one in the garage and one outside the garage, catch fire at the same time, can be simulated.

The dummy vehicle is preferably configured such that the rechargeable battery dummy or at least one rechargeable battery dummy and/or the dummy tire or at least one dummy tire can be activated, while the dummy vehicle is located inside the garage. The dummy vehicle in the garage then discharges fog and flames, preferably first fog and then flames. Furthermore, it is made possible that the dummy vehicle outside the garage discharges fog and flames, preferably first fog and then flames. The garage may make it difficult to access the dummy vehicle. The correspondingly configured fire training facility simulates this situation.

It is possible that a dummy charging station with a dummy cable is additionally arranged inside the garage. This embodiment simulates the situation that an electric vehicle catches fire while it is located in a garage, a charging station is arranged in the garage and the charging station charges at least one rechargeable battery via a cable.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective view of the fire training facility according to the exemplary embodiment, wherein the fire training facility comprises a garage, a dummy car, a dummy charging station and a trolley with four gas cylinders;

FIG. 2 is a side view of the fire training facility from FIG. 1;

FIG. 3 is a front view of the fire training facility from FIG. 1;

FIG. 4 is a top view of the fire training facility from FIG. 1;

FIG. 5 is the dummy car in the plane B-B from FIG. 2; and

FIG. 6 is a schematic showing of an exemplary rechargeable battery dummy.

### DESCRIPTION OF PREFERRED EMBODIMENTS

Referring to the drawings, the fire training facility according to the exemplary embodiment is capable of generating different situations in a realistic manner, wherein these generated situations can simulate such situations that may occur with an electric drive during the fire of a real road vehicle, especially of a passenger motor vehicle. As is well known, the electric drive of a car comprises an electric motor and at least one rechargeable battery, usually a plurality of rechargeable batteries. The electric motor and the rechargeable batteries are located onboard the vehicle. It is also possible that a car is driven, as desired, by an electric drive or by an internal combustion engine (hybrid drive) and hence comprises both an electric drive and an internal combustion engine and thus also both at least one rechargeable battery and a fuel tank. All these components are arranged onboard the vehicle. The fire training facility of the exemplary embodiment is capable of simulating both the fire of a car, which has exclusively an electric drive, and the fire of a car with hybrid drive. In addition, the fire training facility of the exemplary embodiment is capable of simulating the fire onboard a real car, which has an internal combustion engine, at least one rechargeable battery, an electric motor as well as a generator, wherein the internal combustion engine drives the generator and the driven generator charges the rechargeable battery or each rechargeable battery.

In the exemplary embodiment, the dummy car simulates a passenger vehicle. It is also possible to use a dummy, which simulates another road vehicle with only electric drive or hybrid drive, for example, a truck, a forklift, a lift truck, a bus, another commercial vehicle or a two-wheeler (e.g., E bike, E scooter, E motorcycle), or even an agricultural vehicle, for example, a combine harvester, a forage harvester, a loading vehicle or a bale press, wherein an electric drive moves at least one component of this agricultural vehicle. It is also possible that the dummy simulates an electrically driven railway vehicle, for example, an electric locomotive, a rail bus, a tram or an omnibus or O bus (trolley bus). The dummy vehicle, which simulates this railway vehicle, likewise comprises at least one rechargeable battery dummy. A railway vehicle may comprise such a rechargeable battery in order to be able to travel along a section without overhead wire and without bus bar.

The rest of the exemplary embodiment pertains to a fire training facility, which simulates the fire of an electrically driven or hybrid-driven passenger motor vehicle (electric car). The fire training facility makes it easy to simulate at least one situation, which may occur during the fire of a real electric car. Firefighters and rescue crew members may train at the fire training facility on an action adapted to the situation during the fire of an electric car.

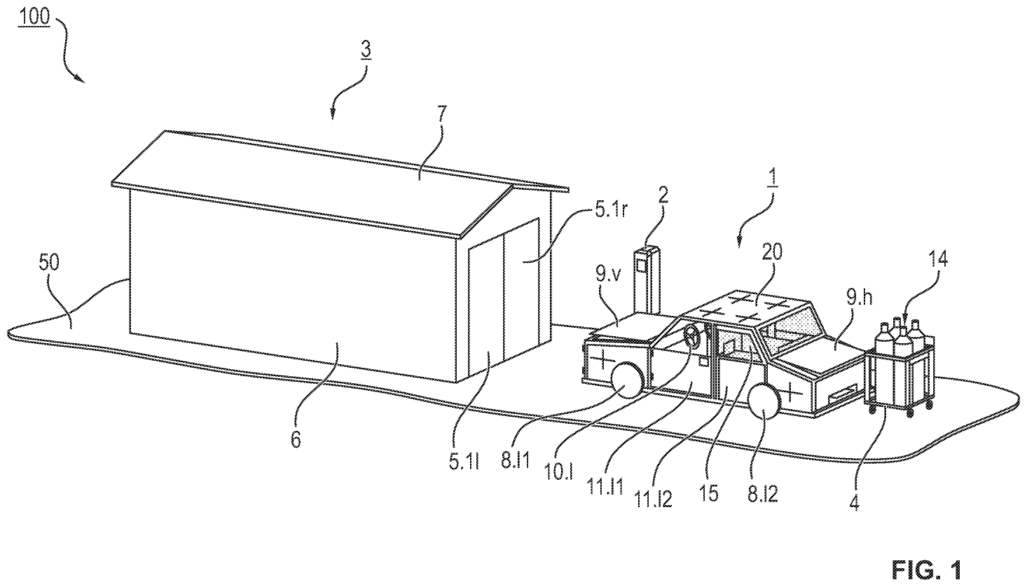

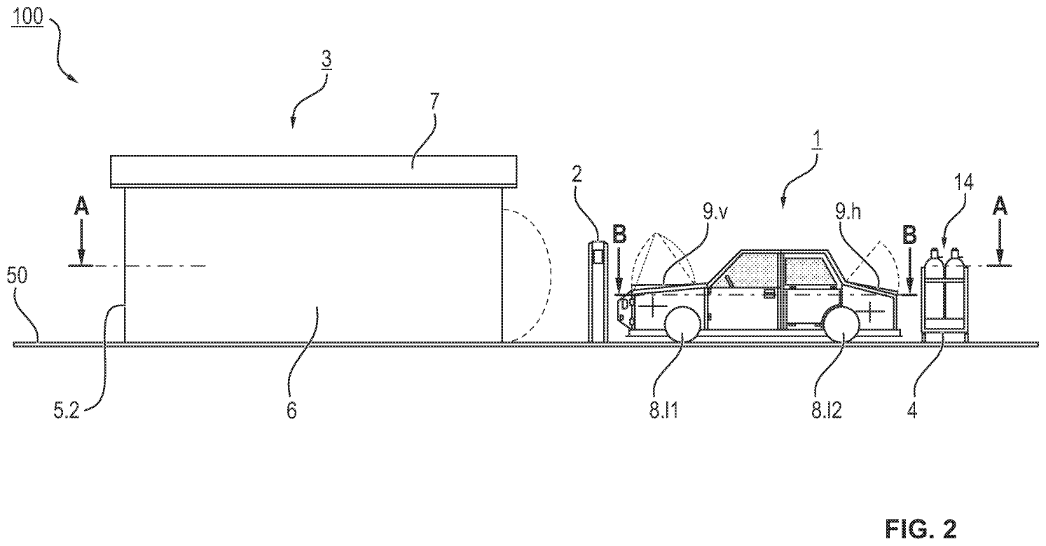

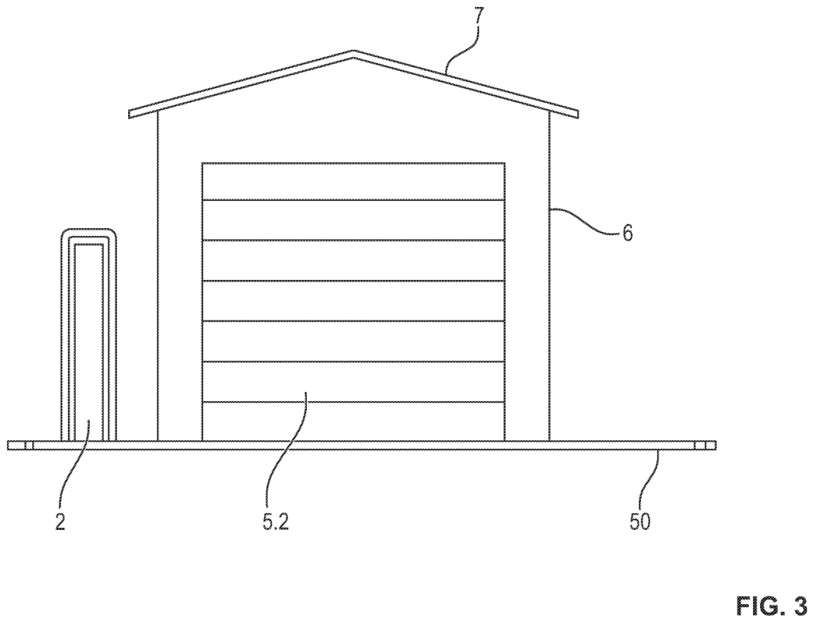

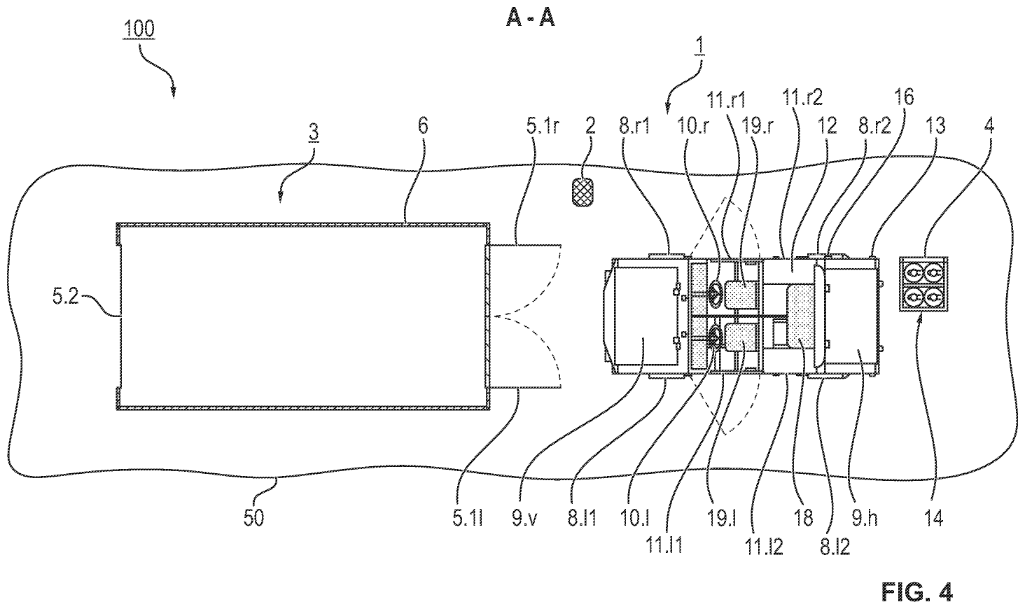

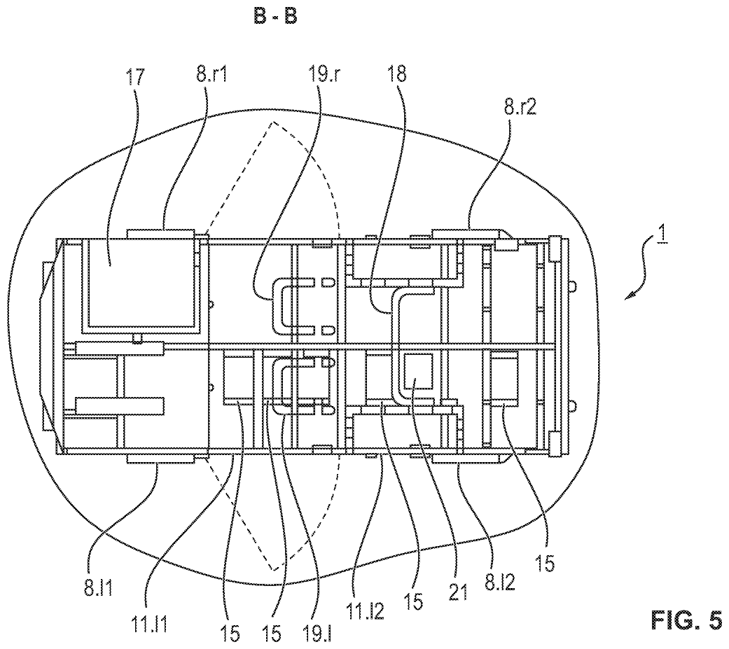

FIG. 1 through FIG. 4 show a fire training facility 100 according to an exemplary embodiment of the present invention from four viewing directions, namely in a perspective view obliquely from the top (FIG. 1), in a side view (FIG. 2), in a front view (FIG. 3) and in a top view (FIG. 4). The terms “side view” and “front view” pertain to the direction of greatest extension (longitudinal axis) of the fire training facility 100. This longitudinal axis lies in the drawing planes of FIG. 2 and FIG. 4 and is at right angles to the drawing plane of FIG. 3. FIG. 4 shows in a top view the fire training facility in the horizontal plane A-A of FIG. 2. FIG. 5 shows in a top view the dummy car in the horizontal plane B-B of FIG. 2.

The fire training facility 100 of the exemplary embodiment comprises
a dummy 1 of a real four-door car,
a dummy 2 of a charging station for charging the rechargeable batteries of a real electric car,
a garage (carport) 3,
a trolley (movable transport unit) 4 with four gas cylinders 14, and
a fireproof and heat-resistant base 50, on which the other components 1, 2, 3, 4, 14 are located.

The term “dummy” of an object denotes a physical simulation of an object, whereby this simulation has the external dimensions and at least approximately the outer contour of the simulated object and is, in addition, then capable of simulating a fire of the simulated object, when the simulated real object is combustible. The dummy is preferably capable of generating at least some of the physical and chemical effects that occur or may occur during a fire of the simulated object. Components of the simulated object, which are not necessary for the simulation of the fire, may be absent in the case of the dummy 1. In particular, it is possible that the dummy 1 does not comprise a simulation of an electric motor and/or a simulation of a dashboard (cockpit).

The dummy car 1 of the exemplary embodiment has the external dimensions of a common passenger motor vehicle for four or five passengers and simulates a car, the longitudinal axis of which corresponds to the longitudinal axis of the fire training facility and which travels from right to left in the example from FIG. 1, FIG. 2 and FIG. 4. The terms “left” and “right” for the components of the dummy car 1 pertain to this travel direction.

The dummy car 1 comprises the following components:
a vehicle body 20,
the dummies of two left wheels 8.l1 and 8.l2 as well as the dummies of two right wheels 8.r1 and 8.r2, wherein the four dummy wheels 8.l1, 8.l2, 8.r1, 8.r2 are preferably fastened to the vehicle body 20 in a rotatable manner, so that the dummy car 1 can be rolled over a base,
a front lid hood 9.v and a rear lid 9.h in the vehicle body 20, which simulate a trunk lid and an engine compartment lid hood, respectively,
two left doors 11.l1, 11.l2 and two right doors 11.r1, 11.r2, wherein the two front doors 11.l1, 11.r1 are shown as open and the two rear doors 11.l2, 11.r2 are shown as closed in FIG. 5,
the dummies of a plurality of rechargeable batteries 15, wherein the dummy rechargeable batteries 15 are arranged inside the vehicle body 20 and are preferably hollow,
an electrical terminal 16 at the vehicle body 20,
optionally a fuel tank 17 in the vehicle body 20 with a tank cap at the vehicle body 20,
a left front seat 19.l and a right front seat 19.r,
a left steering wheel 10.l and a right steering wheel 10.r in front of the two front seats 19.l, 19.r,
optionally a dummy, not shown, of a brake pedal, and
a continuous seat bench 18 inside the vehicle body 20.

In one embodiment, at least one rechargeable battery dummy 15 is located under a hood or lid 9.v or 9.h and an additional rechargeable battery dummy 15 is located under a front seat 19.l, 19.r or under the seat bench 18.

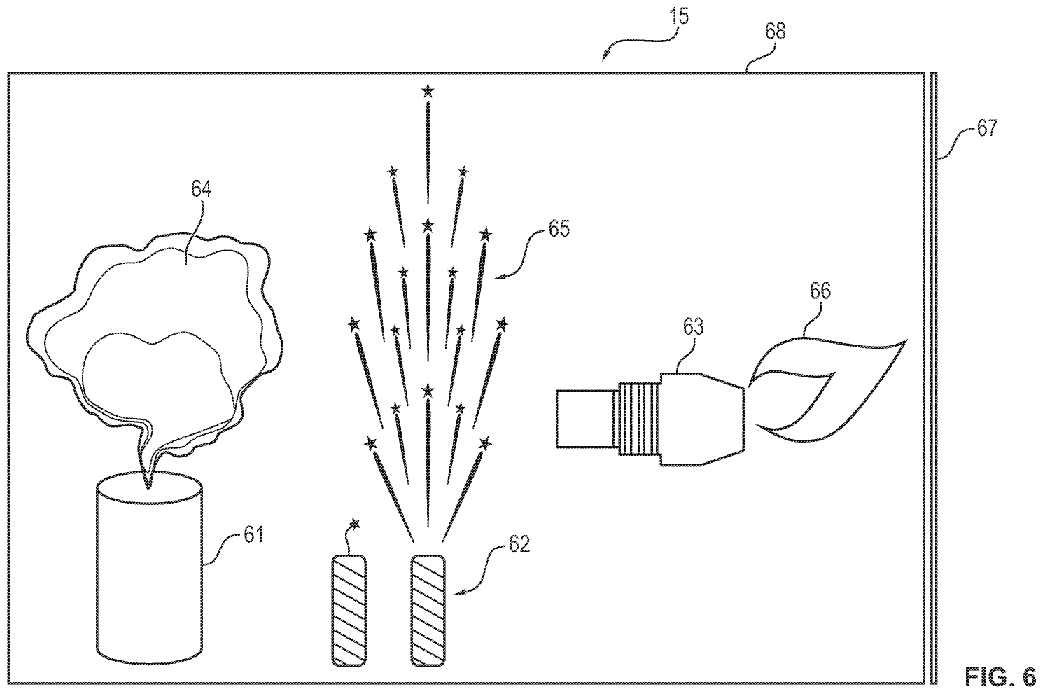

FIG. 6 schematically shows an exemplary rechargeable battery dummy 15. The rechargeable battery dummy 15 comprises the following components:
a smoke pot or fog pot 61,
a component 62 with pyrotechnics comprising firework rockets,
a burner 63 for a combustible fluid, especially for propane in the gaseous or liquid form,
preferably a tank, not shown, for the combustible fluid, and
a plate 67.

The plate 67 is mounted detachably on a surface of the rechargeable battery dummy 15, which has a cuboid shape in the example, for example, on a housing 68 of the rechargeable battery dummy 15. The plate can be fastened and detached again.

The smoke pot or fog pot 61 and the pyrotechnics component 62 belong to the smoke pot or fog pot of the rechargeable battery dummy 15. The pyrotechnics component 62 and the burner 63 belong to the flame generator of the rechargeable battery dummy 15.

The three components 61, 62, 63 can preferably be actuated and thereby activated independently of one another. The activated smoke pot or fog pot 61 discharges fog 64. The activated pyrotechnics component 62 discharges flames and fog 65. When the burner 63 ignites a combustible fluid, then a flame 66 is released. In case the combustible fluid is a combustible liquid, then this flame 66 spreads especially rapidly.

Instead of two steering wheels 10.l, 10.r, cf. FIG. 4, a single steering wheel may also be provided, which can be fastened, as desired, in front of the left front seat 19.l or in front of the right front seat 19.r. Both embodiments take into consideration the possibility that a car and thus also an electric car, which catches fire, may be a car with a left-hand drive or a car with a right-hand drive. It is also possible that the dummy car 1 comprises a steering wheel, which is fastened permanently in front of the left front seat 19.l.

Due to legal requirements, a brake pedal in a real car is produced from a sufficiently stable material, usually from steel or from another metal. It may be necessary in the case of a real fire to cut off this brake pedal in order to rescue a trapped passenger and/or to gain access to an object inside the car. In one embodiment, the dummy car 1 hence comprises a dummy brake pedal, which has the outer shape of a brake pedal and can be removed with such a tool, with which a real brake pedal can also be cut off.

The dummy car 1 further comprises the following components, which are not necessarily present in a real car:
a switch box 12 and
a gas port 13.

The dummy car 1 is manufactured, for example, using a real used car, for example, a car which is ready for the junk yard. It is also possible that sheet metal parts are welded together to form the dummy car 1.

The dummy car 1 can be pushed over the base 50 thanks to the rotatably mounted dummy wheels 8.l1, 8.l2, 8.r1, 8.r2, without having to raise the dummy car 1. It is possible, but not necessary, for the simulation of a fire that the dummy car 1 has a functioning drive, a functioning steering and a functioning brake. The dummy wheels 8.l1, 8.l2, 8.r1, 8.r2 may be mounted on two axles, not shown. It is also possible that the dummy wheels 8.l1, 8.l2, 8.r1, 8.r2 are fastened rotatably to the vehicle body 20, i.e., quasi via independent suspension.

The fire training facility 100 comprises a garage (carport) 3 to simulate the situation that an electric car in a garage catches fire. In the exemplary embodiment, when the dummy car 1 is in the garage 3, a space of less than 1 m is present in any direction between the dummy car 1 and the closest wall of the garage 3. This embodiment simulates in an especially realistic manner the situation that an electric car catches fire inside a garage, wherein the garage is only relatively slightly larger than the electric car. The dummy car 1 can be put, as desired, into a position,
in which it is entirely enclosed by the garage 3,
in which it is partially enclosed by the garage 3, or
in which it is located entirely outside the garage 3.

The garage 3 of the fire training facility 100 has a rectangular base and comprises
four vertical walls 6, namely two longitudinal walls and two front walls,
a roof 7,
a wing door with two wings 5.1l and 5.1r in the front wall, which points towards the dummy car 1 in the view from FIG. 2, as well as a roll-up door 5.2 in the opposite front wall.

In addition to or instead of the doors 5.1l, 5.1r and 5.2, the garage 3 may also comprise an overhead door or a sectional door. The garage 3 encloses a cuboid space, which is capable of accommodating the dummy car 1.

The fire training facility 100 of the exemplary embodiment further comprises a dummy 2 of an electrical charging station in order to simulate the situation that an electric car catches fire while the electric car is electrically connected to a charging station via a charging cable and the rechargeable batteries of the electric car are being charged or have already been charged. In the exemplary embodiment, the dummy charging station 2 is located outside the garage 3. The dummy charging station 2 may also be arranged inside the garage 3, because a charging station may also be present inside a real garage. It is also possible that the fire training facility 100 comprises a dummy charging station 2 outside the garage and an additional dummy charging station (not shown) in the garage 3.

The dummy charging station 2 has the external dimensions of a real charging station. The dummy charging station 2 preferably comprises an electric cable or the replica of an electric cable, this cable or this cable replica being connected to the dummy charging station 2 and being able to be inserted into the electrical terminal 16 of the dummy car 1. The dummy charging station 2 in one embodiment is actually capable of providing electrical energy for electrical consumers onboard the dummy car 1. It is possible to lock the cable replica in a corresponding receptacle of the dummy car 1 in order to simulate the situation that a real charging cable or a real receptacle for a charging cable is locked and becomes deformed or melts because of the fire and the charging cable therefore can no longer be pulled out of the receptacle.

The four gas cylinders 14 can be moved to the gas port 13 of the dummy car 1 by means of the trolley 4, and each gas cylinder 14 can be removed from the trolley. Liquid gas from the gas cylinders 14 can be introduced into fluid tanks of components of the dummy car 1, which is further described in more detail below. Of course, a different number of gas cylinders or a different way to bring liquid gas to the dummy car 1 is also possible.

The switch box 12 belongs to a signal-processing control device and is capable of actuating various final control elements of the dummy car 1. A user may preferably predefine a sequence at an actuating element or at another user surface of the switch box 12, for example, by the user selecting individual steps and/or he may select one of a plurality of predefined and stored, possible sequences and predefine same in this manner. The predefined and selected sequence simulates a situation that may occur during the fire of an electric car. The same fire training facility 100 according to the present invention may implement different sequences one after the other and consequently simulate various situations that may occur during the fire of an electric car. In particular, different orders can be predefined, wherein each predefined order specifies a respective sequence, in which a respective generator onboard the dummy vehicle 1 discharges fog and/or flames. In addition, the different components of the fire training facility 100 can preferably be locked or opened, for example, a door 5.1l, 5.1r, 5.2 of the garage 3 or a component of the dummy vehicle 1.

A possible sequence is the following sequence: First, the dummy car 1 discharges slightly volatile dense smoke by generating fog with a lower pressure. It [dummy car] then discharges intense dense smoke by generating fog with increased pressure. The dummy car 1 then generates light flames. Finally, it generates a large amount of flames, for which it lights fireworks. For this purpose, the smoke pot or fog pot and the flame generator described above are actuated and thereby activated one after the other.

In the exemplary embodiment shown, the dummy car 1 is located in front of the garage 3. In the situation shown, the event that an electric car catches fire while it is located entirely outside the garage can be simulated.

The dummy car 1 can preferably be put into a position, in which it is located partially or entirely in the garage 3. Even when the dummy vehicle 1 is entirely or partially in the garage 3, the dummies for the components of the car can be used and then generate flames and dense smoke as in case of the fire of a real component. As a result, the situation can be simulated that an electric car catches fire while it is in a garage and the access to the car may be restricted. At least one of the following situations can preferably be established as desired:
The wing doors 5.1l, 5.1r as well as the roll-up door 5.2 at the two front walls of the garage 3 are open.
The wing doors 5.1l, 5.1r as well as the roll-up door 5.2 at the two front walls are closed, but can be opened with a respective key, wherein this key is also available.
Neither the wing doors 5.1l, 5.1r nor the roll-up door 5.2 can be opened by means of a key, for example, because a key is not available or a mechanism for opening is defective. The wing doors 5.1l, 5.1r and/or the roll-up door 5.2 in this situation have to be broken open from outside in order to gain access to the dummy car 1 in the garage 3.

Each of these situations simulates a situation, which may occur in reality and therefore should be trained on.

The fire of a rechargeable battery therefore usually comprises a sequence of different events, which can be called a chain reaction. The rechargeable battery dummy 15 simulates at least one typical sequence during the fire of a rechargeable battery, and preferably one of a plurality of possible situations, as desired.

If a real rechargeable battery catches fire, then at first dense smoke usually develops, and then the rechargeable battery burns and thereby radiates a lot of thermal energy. In order to simulate these effects, each rechargeable battery dummy 15 onboard the dummy car 1 is capable of generating both dense smoke and fog as well as flames. For example, a container and an over pressure generator are arranged inside the rechargeable battery dummy 15 or at least close to the rechargeable battery dummy 15, wherein the over pressure generator is capable of generating pressure and wherein the generated pressure discharges artificial fog from the container. The flames are generated, for example, by means of ground-based fireworks, which has a configuration similar to New Year's fireworks, or by burning gas in the liquid and/or gaseous form, cf. FIG. 6. In one embodiment, the rechargeable battery dummy or each rechargeable battery dummy 15 comprises a respective tank for a combustible fluid, wherein this fluid is set on fire in order to generate flames.

In one embodiment, liquid gas can be introduced from the gas cylinders 14 through the gas port 13 into a container for the dummy rechargeable batteries 15. The gas cylinders 14 are connected in a fluid-tight manner to the gas port 13, gas flows into the container, and then the gas cylinders 14 are again detached from the gas port. Before a fire is triggered onboard the dummy car 1, the trolley 4 with the gas cylinders 14 is put out of reach of the fire that has been caused.

The switch box 12 preferably actuates at least one respective final control element of the rechargeable battery dummy 15. The actuation preferably causes the following effect: The actuated rechargeable battery dummy 15 first generates dense smoke and/or fog and then fire. It is possible that all dummy rechargeable batteries 15 are actuated at the same time and each generate dense smoke at first and then fire. It is further possible that the dummy rechargeable batteries or even only individual dummy rechargeable batteries 15 are actuated one after the other. The order, in which the dummy rechargeable batteries 15 are actuated, can be predefined.

In the example from FIG. 6, the switch box 12 preferably first activates the smoke pot or fog pot 61, which then generates fog 64. The switch box then activates the pyrotechnics component 62, and then more fog as well as flames appear. Finally, the switch box 12 activates the burner 63, and the activated burner 63 burns a combustible fluid from the gas cylinders 14. This sequence simulates the processes during the fire of a real rechargeable battery in an especially realistic manner.

In some cases, first at least one tire catches fire during a fire of a vehicle with an electric derive, and the tire on fire sets a rechargeable battery on fire. In order to simulate this process, the fire training facility according to the present invention is configured in one embodiment as follows: At first, the flame generator of a dummy tire 8.l1, 8.l2, 8.r1, 8.r2 is actuated and starts to generate flames. The rechargeable battery dummy or at least one rechargeable battery dummy 15 is then actuated. The smoke pot or fog pot of the actuated rechargeable battery dummy 15 starts to generate fog. Or else, the flame generator of the actuated rechargeable battery dummy 15 starts to generate flames. In case the dummy vehicle 1 comprises a plurality of dummy rechargeable batteries, then the rechargeable battery dummy 15, which is closest to the previously actuated dummy tire 8.l1, 8.l2, 8.r1, 8.r2, is preferably actuated.

This embodiment may be combined with one of the embodiments described further above as follows: First, the flame generator of one dummy tire 8.l1, 8.l2, 8.r1, 8.r2 generates flames. The smoke pot or fog pot of a rechargeable battery dummy 15 then generates fog. The flame generator of this rechargeable battery dummy 15 then generates flames.

In one embodiment, the fire training facility 100 of the exemplary embodiment enables a firefighter to train on the following process when putting out a fire in a rechargeable battery: The firefighter inserts a rigid fog nozzle into the rechargeable battery, so that a part of the fog nozzle is located inside the rechargeable battery. The fog nozzle comprises a hollow tube. A feed unit feeds an extinguishing liquid into the interior of the fog nozzle, and the fog nozzle sends this extinguishing liquid through the hollow pipe into the interior of the rechargeable battery.

In order to train on this operation, the firefighter may pierce the plate 67 with a real fog nozzle at least once and cause an extinguishing liquid to flow into the interior of the rechargeable battery dummy 15. It is possible that a plurality of fog nozzles are pushed through the same plate 67. After a training mission, the plate 67 is perforated. Because it is fastened in a detachable manner, it can be easily replaced with a new plate.

As is well known, a combustion process needs oxygen. In one preferred embodiment, each rechargeable battery dummy 15 comprises a valve and an actuating drive for this valve. With the valve open, oxygen can flow into the container of the rechargeable battery dummy 15, which container is filled with gas, and can feed a fire there. With the valve closed, no oxygen or at least less oxygen flows into the interior, and the fire is extinguished. At the beginning of a mission, the valves of the rechargeable battery dummy 15 are open. In case the fire shall be ended rapidly or prematurely, a user then actuates an actuating element, not shown, which activates the drives for the valves and is preferably attached to the switch box 12. The activated drives close the valves. A respective spring is in one embodiment associated with each valve, and the associated spring strives to hold the valve in the closed position. A drive opens the valve against the spring force, and the valve preferably snaps in the open position. In case the actuating element is actuated, the optional snapping in of the valve is eliminated, and the spring closes the valve. In case of failure of the drive, the valve is brought into the closed position by the spring.

In a real car both the engine compartment hood and the trunk lid can usually be opened by means of a respective actuating element from the interior of the vehicle. The respective axis of rotation of this hood or lid can—as viewed in the travel direction of the car—be arranged in front of or behind the hood or lid depending on the configuration. The engine and/or the rechargeable batteries may be located under the front hood or under the rear lid depending on the configuration. In a real fire, these actuating elements may not, however, be accessible or may be blocked or be damaged or blocked. In addition, it is often unknown to a firefighter what is located under the hood or lid of a certain burning car. It is also possible that a hood or lid is dented or blocked in a different way.

In order to be able to simulate situations different from reality, preferably both the front hood 9.v and the rear lid 9.h can be opened, as desired, about a front axis or about a rear axis, wherein the front axis is located in the travel direction in front of the hood or lid 9.v, 9.h and the rear axis is located in the travel direction behind the hood or lid 9.v, 9.h. In addition, a situation, in which the two lids hood and lid 9.v, 9.h can be opened by a respective actuating element in the interior of the car, and a situation, in which this is not possible, for example, because both the hod and the lid are blocked, may be simulated, as desired.

In the case of a real car with an electric drive, both the battery and a cable harness can be heated and then discharge dense smoke, wherein this dense smoke obstructs the view. In order to simulate this event, a smoke pot or fog pot 21 is preferably arranged under the seat bench 18. This smoke pot or fog pot 21 can be actuated from outside and is capable of discharging fog after a corresponding actuation.

In case of a real fire of a car with an electric drive, at least one tire of the burning car also frequently catches fire. A possible cause is the intense heat that develops during a fire of a rechargeable battery. In addition, when the car additionally has an internal combustion engine and hence also a fuel tank, liquid fuel may also be released and burn. Lubricant may also be released and burn.

In order to simulate this situation, each dummy tire 8.l1, 8.l2, 8.r1, 8.r2 may simulate the fire of a tire, preferably of a tire made of rubber. In one embodiment, each dummy tire 8.l1, 8.l2, 8.r1, 8.r2 comprises a respective tank for liquid combustible gas as well as a burner. This burner may ignite liquid gas, which is released from the tank of the dummy tire 8.l1, 8.l2, 8.r1, 8.r2, and as a result may simulate a fire of a real tire. The tank is preferably in fluid connection with the gas port 13. It is also possible that each dummy tire 8.l1, 8.l2, 8.r1, 8.r2 has a plurality of respective points, at which flames may be released. This embodiment simulates the situation that a real tire may also catch fire at different points. It is also possible that the release of flames at a certain point is simulated by means of a nozzle. Each dummy tire 8.l1, 8.l2, 8.r1, 8.r2 is manufactured from rubber in one embodiment.

It is possible that a dummy tire 8.l1, 8.l2, 8.r1, 8.r2 additionally has a nozzle which sprays out liquid gas. The burner ignites the sprayed-out liquid gas. It is possible that fog is additionally released, wherein this fog being released simulates the situation that smoke rises and obstructs the view in case of the fire of a real tire made of rubber. This fog can be generated by a smoke pot or fog pot of a rechargeable battery dummy 15 or by a smoke pot or fog pot of the dummy tire 8.l1, 8.l2, 8.r1, 8.r2, which the smoke pot or fog pot has a preferably similar configuration.

The switch box 12 actuates at least one respective final control element of each dummy tire 8.l1, 8.l2, 8.r1, 8.r2, and the actuation causes flames and optionally fog to be generated at the dummy tire 8.l1, 8.l2, 8.r1, 8.r2.

A car may have, in addition to the electric drive, an internal combustion engine and a fuel tank (hybrid drive). In case of a real fire of a car with a motor vehicle fuel tank, an attempt is frequently made to stop the feed of oxygen to the fuel tank in order to prevent the heated fuel from being ignited. In addition, an extinguishing liquid shall in some cases be introduced into the fuel tank. In order to achieve at least one of these two goals, it is necessary to open a tank cap. In one embodiment, the dummy car 1 therefore comprises a dummy 17 of a fuel tank with a tank cap, wherein the dummy tank 17 additionally comprises a mechanism, which makes it difficult to open the tank cap, for example, a magnetic closure, or even locks the tank cap. Fuel or another combustible fluid may be contained in the dummy tank 17.

While specific embodiments of the invention have been shown and described in detail to illustrate the application of the principles of the invention, it will be understood that the invention may be embodied otherwise without departing from such principles.

### LIST OF REFERENCE NUMBERS

1. Dummy car; it comprises the vehicle body 20, the dummy wheels 8.l1, 8.l2, 8.r1, 8.r2, the lids 9.v and 9.h, the steering wheels 10.l and 10.r, the doors 11.l1, 11.l2, 11.r1, 11.r2, the dummy rechargeable batteries 15, the electrical terminal 16, the fuel tank 17, the seat bench 18, the front seats 19.l and 19.r, the optional smoke pot or fog pot 21 and the switch box 12
2. Dummy charging station; it is located on the base 50; it comprises a dummy of a charging cable
3. Garage (carport); it comprises the walls 6, the roof 7, the wing doors 5.1l, 5.1r and 5.2] as well as the roll-up door 5.2; it is capable of fully accommodating the dummy car 1
4. Movable trolley for four gas cylinders 14
5.1l, 5.1r. Wing doors at a front wall of the garage 3
5.2. Roll-up door at a front wall of the garage 3
6. Walls of the garage 3
7. Roof of the garage 3
8.l1, 8.l2. Dummies of the left wheels; they belong to the dummy car 1
8.r1, 8.r2. Dummies of the right wheels; they belong to the dummy car 1
9.h. Rear lid in the vehicle body 20 of the dummy car 1
9.v. Front lid hood in the vehicle body 20 of the dummy car 1
10.l. Left steering wheel of the dummy car 1; it is located in front of the left front seat 19.l
10.r. Right steering wheel of the dummy car 1; it is located in front of the right front seat 19.r
11.l1, 11.l2. Left doors in the vehicle body 20 of the dummy car 1
11.r1, 11.r2. Right doors in the vehicle body 20 of the dummy car 1
12. Switch box, by means of which a user can predefine a procedure for the simulated burning of an electric car; it belongs to a signal-processing control device of the dummy car 1
13. Gas port in the vehicle body 20 of the dummy car 1 for the gas cylinders 14
14. Gas cylinders in the trolley 4; they can receive gas and can be connected to the gas port 13 and can be separated from the gas port 13 again
15. Dummy rechargeable batteries in the vehicle body 20 of the dummy car 1; they are capable of generating dense smoke and fire
16. Electrical terminal in the vehicle body 20 of the dummy car 1 for 220 V and optionally for 400 V
17. Dummy of a tank with a tank cap in the vehicle body 20
18. Rear seat bench in the dummy car 1
19.l, 19.r. Front seats in the dummy car 1; they are located behind the steering wheels 10.l and 10.r
20. Vehicle body of the dummy car 1
21. Optional smoke pot or fog pot under the rear seat bench 18
50. Fireproof and heat-resistant base, on which the dummy car 1, the dummy charging station 2 and the garage 3 are located
61. Smoke pot or fog pot of the rechargeable battery dummy 15
62. Component with pyrotechnics of the rechargeable battery dummy 15
63. Burner of the rechargeable battery dummy 15
64. Fog, which the smoke pot or fog pot 61 generates
65. Flames and fog, which the pyrotechnics component 62 generates
66. Flame, which the burner 63 generates
67. Detachably mounted plate; it is mounted at the housing 68; it forms an area of the outer surface of the rechargeable battery dummy 15; it can be penetrated by a fog nozzle
68. Housing of the rechargeable battery dummy 15; it carries the plate 67
100. Fire training facility; it comprises the dummy car 1, the dummy charging station 2, the garage 3, the trolley 4 with the gas cylinders 14 and the base 50

1. A fire training facility comprising a dummy vehicle, wherein the dummy vehicle has the external dimensions of a vehicle and comprises:
a dummy of a rechargeable battery for the vehicle; and
a dummy of a tire of the vehicle, wherein the rechargeable battery dummy is positioned onboard the dummy vehicle at a possible position of a rechargeable battery onboard the vehicle and comprises a fog generator and a flame generator, wherein the fog generator of the rechargeable battery dummy is configured to generate fog such that the generated fog exits the rechargeable battery dummy, wherein the flame generator of the rechargeable battery dummy is configured to generate flames such that the generated flames exit from the rechargeable battery dummy, wherein the tire dummy is positioned onboard the dummy vehicle at a possible position of a tire on the vehicle and comprises a flame generator, and wherein the flame generator of the tire dummy is configured to generate flames such that the generated flames exit from the tire dummy.

2. The fire training facility in accordance with claim 1, wherein the dummy vehicle further comprises a seat or a seat bench for at least one vehicle passenger, wherein the rechargeable battery dummy is arranged under the seat or under the seat bench.

3. The fire training facility in accordance with claim 1, wherein the dummy vehicle further comprises:
a tank for a combustible fluid; and
a closure, wherein the closure is configured to selectively close or release the tank.

4. The fire training facility in accordance with claim 1, further comprising a signal-processing control device, wherein the control device is configured to actuate the rechargeable battery dummy such that the fog generator of the actuated rechargeable battery dummy starts to generate fog before the flame generator of the actuated rechargeable battery dummy starts to generate flames.

5. The fire training facility in accordance with claim 1, wherein the fog generator of the dummy rechargeable battery comprises:
a fog machine; and/or
a fog generator; and/or
a pyrotechnics component.

6. The fire training facility in accordance with claim 1, wherein the flame generator of the rechargeable battery dummy comprises a pyrotechnics component and a burner for burning a combustible fluid, and the fire training facility further comprises a signal-processing control device, wherein the control device is configured to actuate the rechargeable battery dummy such that the pyrotechnics component is activated and starts to generate flames before the burner is activated and ignites a combustible fluid.

7. The fire training facility in accordance with claim 1, further comprising a signal-processing control device, wherein the control device is configured to actuate the tire dummy and afterwards the rechargeable battery dummy such that the flame generator of the actuated tire dummy starts to generate flames before fog generator of the actuated rechargeable battery dummy starts to generate fog, and/or the flame generator of the actuated dummy rechargeable battery starts to generate flames.

8. The fire training facility in accordance with claim 1, wherein the rechargeable battery dummy comprises a plate made of a metallic material, wherein the plate forms an area of an outer surface of the rechargeable battery dummy and is detachably fastened to another portion of the rechargeable battery dummy.

9. The fire training facility in accordance claim 1, further comprising a charging station dummy, wherein the charging station dummy comprises a cable dummy and wherein the cable dummy is configured to be connected to the dummy vehicle.

10. The fire training facility in accordance with claim 9, wherein the dummy vehicle further comprises a cable receptacle for the cable dummy, wherein the cable dummy is configured to be inserted into the cable receptacle.

11. The fire training facility in accordance with claim 1, further comprising a garage, wherein the garage is dimensioned to accommodate the dummy vehicle and to encircle the accommodated dummy vehicle.

12. The fire training facility in accordance with claim 11, wherein the dummy vehicle is configured to selectively be moved between inside the garage and outside the garage.

13. The fire training facility in accordance with claim 10, wherein the dummy cable is configured to be locked in the cable receptacle.
